(19) United States
(12) Patent Application Publication
(10) Pub. No.: US 2007/0192678 A1
(43) Pub. Date: Aug. 16, 2007

(54) Forms development platform

(76) Inventors: Weng Sing Tang, Singapore (SG); Sze Shen Phua, Singapore (SG)

Correspondence Address: KNOBBE MARTENS OLSON & BEAR LLP, 2040 MAIN STREET, FOURTEENTH FLOOR, IRVINE, CA, 92614, US

(21) Appl. No.: 10/594,172

(22) PCT Filed: Mar. 23, 2005
(86) PCT No.: PCT/SG05/00093

§ 371 Date: Sep. 25, 2006

(30) Foreign Application Priority Data
Mar. 26, 2004 (SG) 200401665-5

(51) Int. Cl. G06F 17/00; G06Q 10/00

(52) U.S. Cl. 715/505; 715/506; 705/1

(57) ABSTRACT

A forms development platform (10) for developing forms, comprising: an attribute design module (22) to graphically design reusable form attributes (81) from a selection of predetermined fields, the attributes (81) having integrated business logic; a form design module (23) to graphically design reusable forms (84) using the form attributes (81), the forms (84) having integrated business logic; and a project design module (21) to design reusable projects (86) by graphically arranging the forms (84) according to a predetermined process flow; wherein the design modules (21, 22, 23) operate independently from each other such that the design of the attributes (81), forms (84) and projects (86) are separate functions, and designed attributes (81), forms (84) and the projects (86) are stored as separate entities.

### TECHNICAL FIELD

The present invention concerns a forms development platform for developing forms.

### BACKGROUND OF THE INVENTION

Forms are found in nearly all commercial web applications to enable user-system interaction. The process of creating forms includes four main tasks: management, content, style and logic. As part of the management task, general form requirements are collated and communicated to a project team for initial prototyping and subsequent development work. Typically, this area is filled by a business driver who is required to understand and refine user requirements into a high level contract and pass it down to a project team for development. The project leader of the project team receives the high level contract and translates the requirements into logical modules or contents, and further specifies the presentation style and functional logic for each module. Once the specifications have been completed, they are communicated to a web designer for stylistic implementation and to a web developer for logical implementation.

This process suffers from problems including loose security, high maintenance, slow development, limited re-usability, lack of control and no separation of duties.

### SUMMARY OF THE INVENTION

In a first preferred aspect, there is provided a forms development platform for developing forms, comprising:

an attribute design module to graphically design reusable form attributes from a selection of predetermined fields, the attributes having integrated business logic;

a form design module to graphically design reusable forms using the form attributes, the forms having integrated business logic; and

a project design module to design reusable projects by graphically arranging the forms according to a predetermined process flow;

wherein the design modules operate independently from each other such that the design of the attributes, forms and projects are separate functions, and designed attributes, forms and the projects are stored as separate entities.

Business logic contained within designed attributes and forms may include validation rules for form input while data is being entered, form output, calculated fields and dependencies on other fields in the form,

The platform may further comprise an attribute library to store designed attributes, a form library to store designed forms or a project library to store designed projects. Advantageously, the design modules allow retrieval of designed attributes, forms or projects for re-use or as templates.

The platform may further comprise a validation engine to validate a form. The form may be validated against open standards, for example, the W3C standard for XForms 1.0, or validated against internal business policies of a business. Internal validation policies may include alpha-numeric or length checks for text fields. Internal validation policies may be stored in a validation policy repository to facilitate re-usability.

The platform may be based on a Java 2 Enterprise Edition platform (J2EE). The platform may be presented to a developer via a desktop application to enable a client-side graphical user interface development. The platform may be server based. The platform may be accessible using a web browser, for example, Microsoft Internet Explorer or Netscape Navigator. By being server-based, form definition files are stored directly on the server-side and eliminate the need for frequent file transfers between server and client, which is expected during the developing and testing stages.

The platform may further comprise an approval system to enable forms to be approved prior to publishing. The approval system may be a centralised system. Advantageously, business users are able to test and evaluate the forms to ensure they conform with business objectives in contrast to technical objectives.

The approval system may comprise:

an Inbox to allow access to individual forms associated with certain users;

an Out-of-Office Mechanism to allow users to indicate an out-of-office status and specify route re-direction or alternative actions;

a Forms Archive to allow forms to be searchable and filtered;

Printing module to allow forms to be printed in a printer-friendly format;

Export module to allow users to export form data in XML or other formats; or

an Administration module to allow remote configuration and monitoring of all forms and their associated routing processes.

The designed form may be interpreted to generate a form or series of related forms in HTML, Wireless Markup Language (WML) or other language for presentation on a specific device or operating system.

The predetermined fields may include input fields such as text fields, password fields or image fields.

The attribute designer module may specify validation, error message and dependencies for form controls within an attribute.

The form designer module may specify validation, error messages and dependencies for attributes, sections and pages within a form. The form designer module may also specify list entities, action types, paging mechanism, pre-form and post-form processing and form persistence. The form designer module may design forms with sections and pages.

The project designer module may specify validation, error messages and dependencies for forms and their encompassed entities. The project designer module may also specify list entities, access control, configurations and publishing mechanism.

In a second aspect, there is provided a method for developing forms, comprising the steps of:

graphically designing reusable form attributes from a selection of predetermined fields, the attributes having integrated business logic;

graphically designing reusable forms using the form attributes, the forms having integrated business logic; and

designing reusable projects by graphically arranging the forms according to a predetermined process flow;

wherein the design of the attributes, forms and projects are separate functions, and designed attributes, forms and the projects are stored as separate entities.

In a third aspect, there is provided a form when developed using the method described.

### BACKGROUND DESCRIPTION OF DRAWINGS

An example of the invention will now be described with reference to the accompanying drawings, in which:

FIG. 1 is a block diagram of the platform;

FIG. 2 is a system interaction diagram of the platform;

FIG. 3A is a screenshot of a form display within a Web browser;

FIG. 3B is a screenshot of a form display within a WAP browser;

FIG. 4 is a first screenshot of the Attribute Designer;

FIG. 5 is a second screenshot of the Attribute Designer;

FIG. 6 is a first screenshot of the Form Designer;

FIG. 7 is a second screenshot of the Form Designer;

FIG. 8 is a third screenshot of the Form Designer;

FIG. 9 is a first screenshot of the Project Designer;

FIG. 10 is a second screenshot of the Project Designer;

FIG. 11 is a third screenshot of the Project Designer;

FIG. 12 is a hierarchical diagram of a project;

FIG. 13 is a system architecture diagram of the platform;

FIG. 14 is a validation model diagram;

FIG. 15 is a process flow diagram for developing a form;

FIG. 16 is a screenshot of a web application; and

FIG. 17 is a screenshot of a form.

### DETAILED DESCRIPTION OF THE DRAWINGS

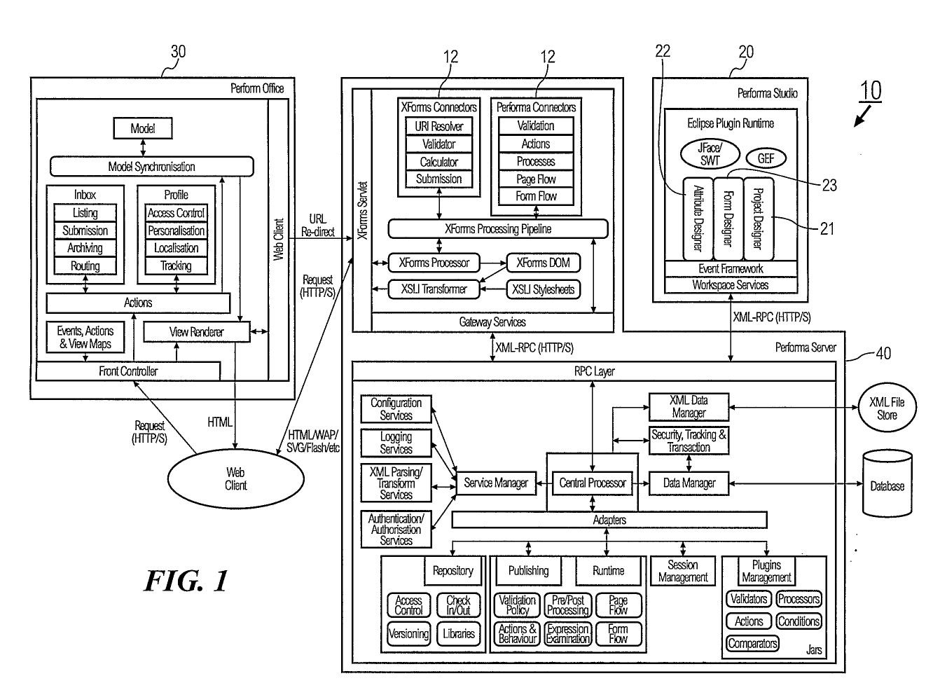

FIG. 1 and the following discussion are intended to provide a brief, general description of a suitable computing environment in which the present invention may be implemented. Although not required, the invention will be described in the general context of computer-executable instructions, such as program modules, being executed by a personal computer. Generally, program modules include routines, programs, characters, components, data structures, that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

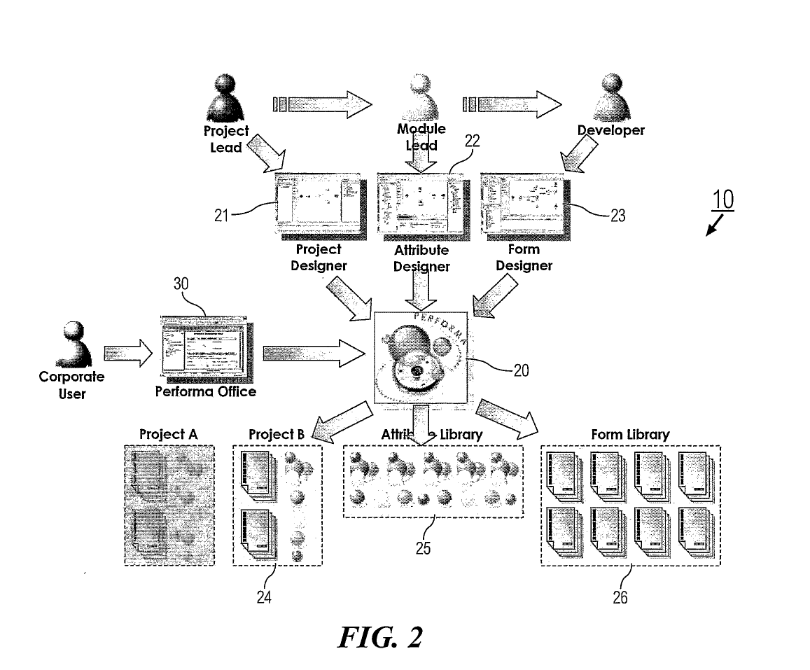

Referring to FIGS. 1 and 2, the platform 10 comprises three functionally distinct applications, Studio 20, Office 30 and Server 40. Studio 20 is an interactive Graphical User Interface (GUI) client application to allow users to visually assemble and bind web-based forms.

Studio 20 includes three design modules: Project Designer 21, Attribute Designer 22 and Form Designer 23. Studio 20 enables users to graphically design attributes, pages, forms, validation policies for the attributes and forms, page flows, form flows and process flows. Validation is important in maintaining the integrity of information within a web application, as well as safeguarding applications from unpredictable behavior resulting from unconstrained user input data. There are two main types of validation: basic validation and policy validation. Basic validation provides data level checks, such as data-type checks and length checks. Basic validation also includes security checks against SQL or script injection. Policy validation involves checks against pre-defined business policies or rules set by the application. The platform 10 provides an intuitive, flexible and reusable approach towards specifying forms validation. An example of a simple attribute that accepts users' NRIC/FIN number in a registration form is depicted in FIG. 14. The input validation 90 required by this attribute includes: verifying that input contains a combination of alphabets and numbers 91, the input length can be either nine characters (NRIC) or twelve characters (FIN) 92, the digit entered must be validated and checked against alphabets based on a selected algorithm 93, and the NRIC/FIN number entered must exist in an existing list of eligible registrants 94. The alphanumeric and length checks 92 are examples of basic validation which can be specified declaratively or selected from a common repository of implemented validation functions. On the other hand, the checking of whether the record exists in the user list constitutes a policy validation as it contains application specific semantics which includes database lookup operations. To support the integration of application specific policy validation, the platform 10 allows proprietary policies to be plugged in through custom Java objects called validators. These validators implement the platform's 10 validator interface and extend base validator functionality. Plugged-in custom validators are automatically stored in a project specific repository and can be reused for other form attributes.

Other validation policies include output data validation. Validation policies are graphically designed and configured. The XML Schema definition (XSD) is an XML-based grammar declaration for specifying data constraints, hierarchical relationships and element namespaces in XML. Its main use is in declaratively specifying a set of rules in governing the validity of XML multiplicity checks and data relational checks. XSD supports namespace conflict handling and data constraint reusability (inheritability), which allows complex data structures and relationships to be defined among documents and elements. The system uses XSD for validating and verifying XML data validity within form documents, as well as system interfaces to ensure that the data exchanged is in the correct format.

Studio 20 facilitates the creation of secure enterprise-level forms for web applications simply by drawing flow charts. Each of these items can be graphically configured within Studio 20 to allow specific behaviors to be customised easily.

Studio 20 abstracts and shields users from the underlying complexity and programming language code.

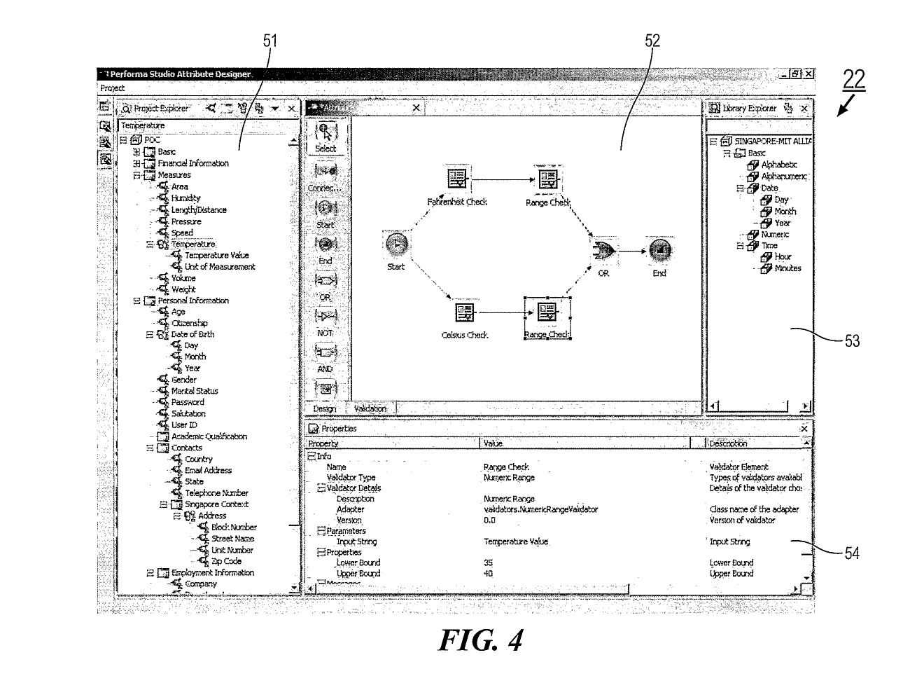

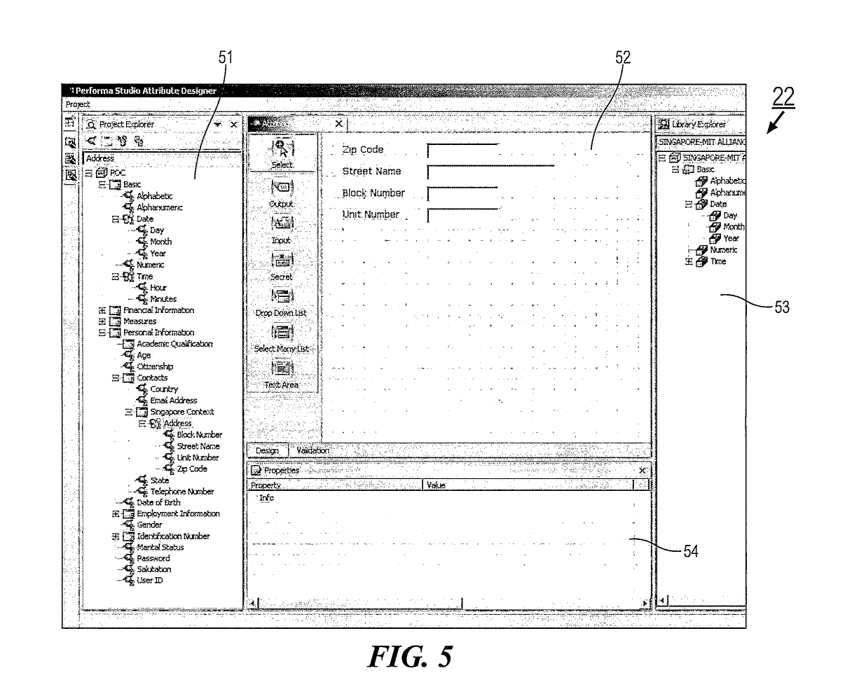

Referring to FIGS. 4 and 5, Attribute Designer 22 is used by a developer to create reusable business attributes from a selection of basic form controls. Attribute Designer 22 also allows validation, error messages and dependencies to be specified for form controls within an attribute. The user interface of Attribute Designer 22 includes a navigation pane 51, work pane 52, library pane 53 and properties pane 54. The navigation pane 51 presents a hierarchical view of a project to allow easy access to encompassed entities. For each selected entity within the navigation pane 51, the work pane 52 renders the associated user interface and validation flow. Users are also able to drag-and-drop form controls and validation elements from the work pane 52 palettes into the containing canvas. Details of selected entities in the navigation 51 and work panes 52 are displayed in the properties pane 54, which can be edited by the user. Optionally, users may import or export attributes from or to a common repository by dragging-and-dropping between the navigation pane 51 and library pane 53.

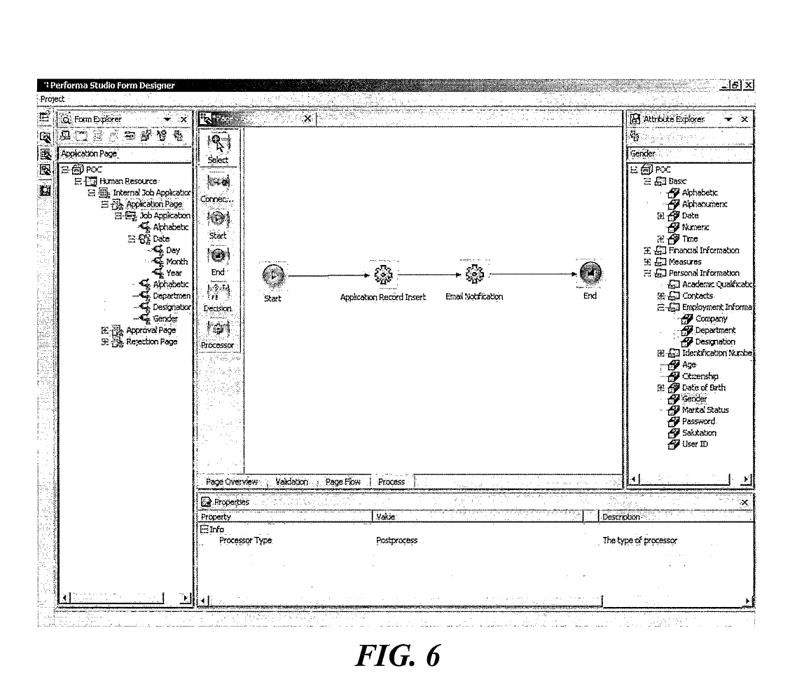

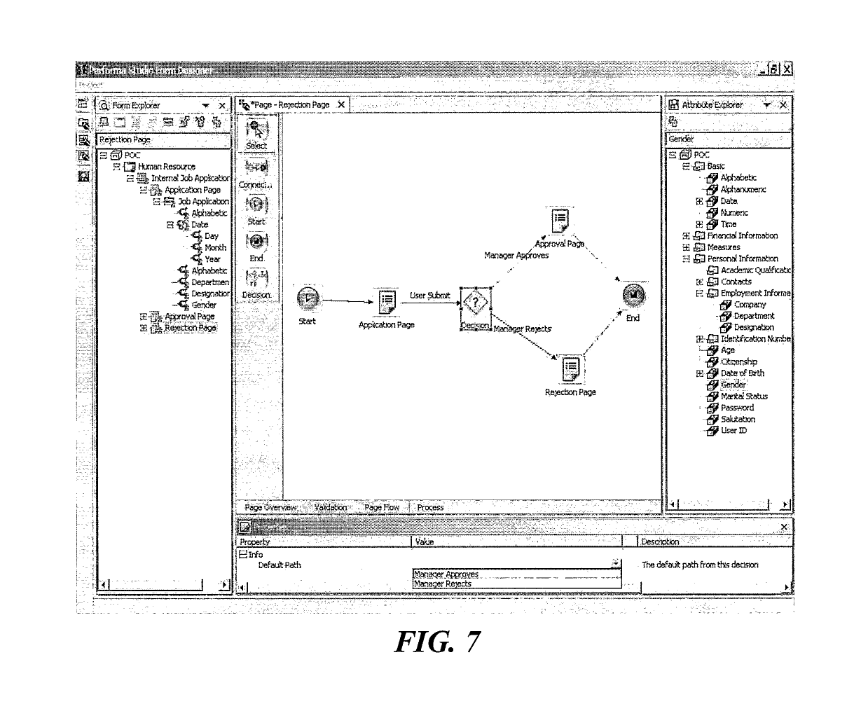

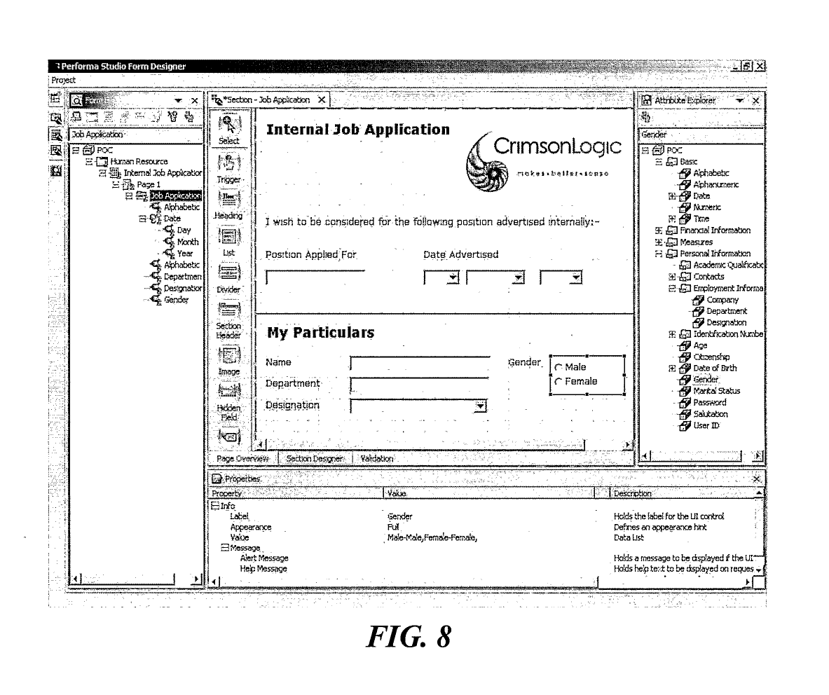

Referring to FIGS. 6 to 8, Form Designer 23 is used by a developer to create forms from a selection of business attributes, along with encompassing sections and pages. Form Designer 23 allows validation, error messages and dependencies to be specified for attributes, sections and pages within a form. Other options include list iterators (dynamic list tables), action (button) types, a paging mechanism, pre and post form processing and form persistence.

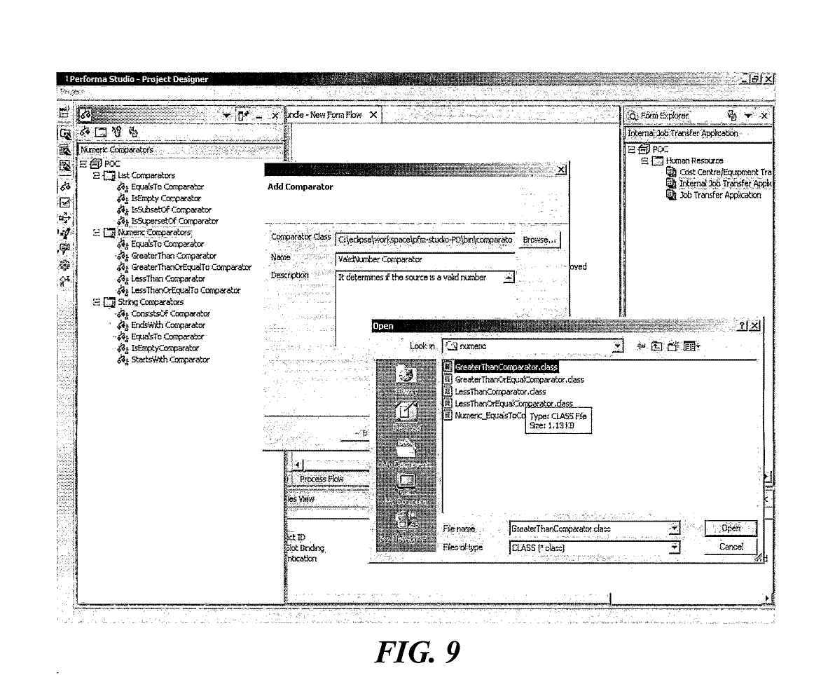

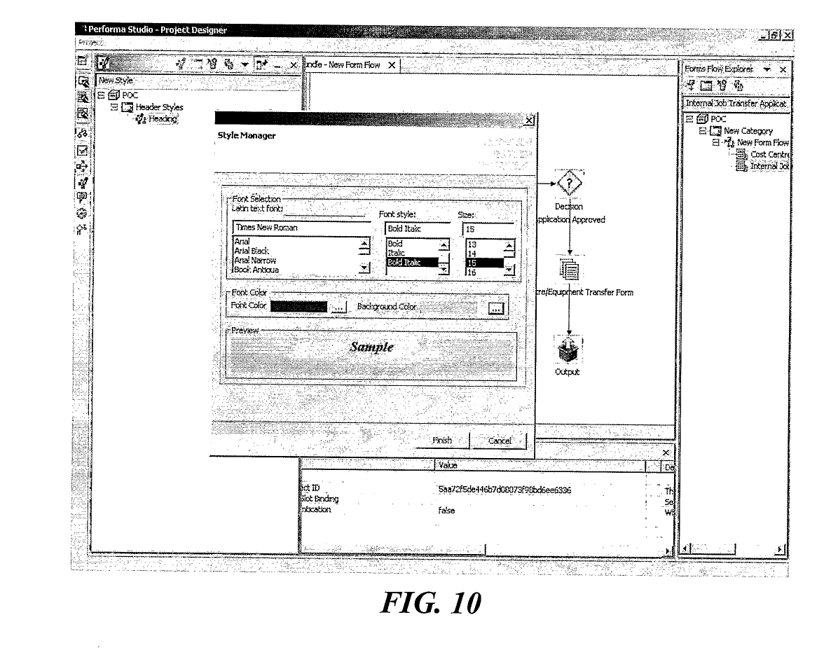

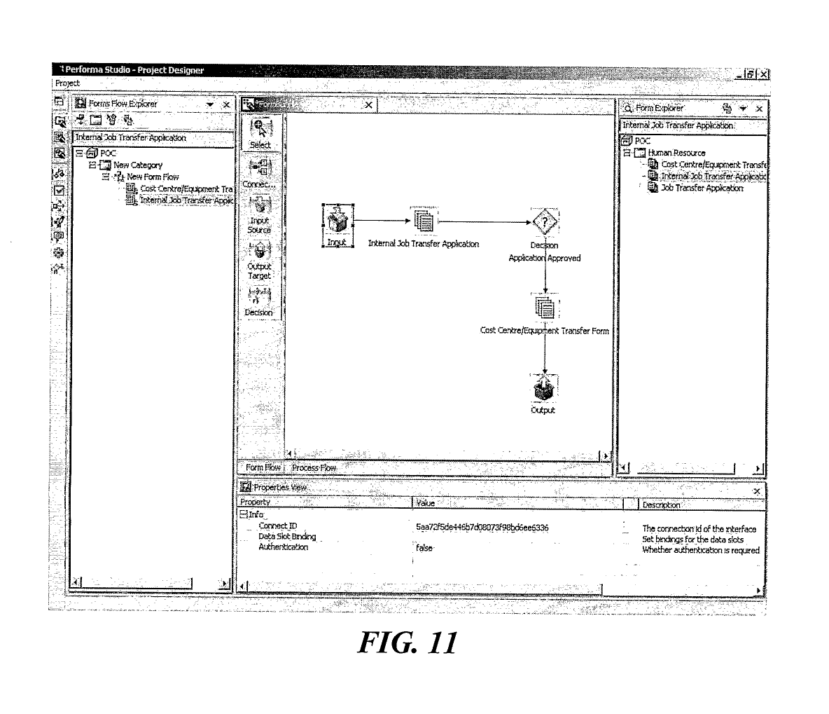

Referring to FIGS. 9 to 11, Project Designer 21 is used by a developer to create projects, specify form bundles, optionally with attachments, form flow and a routing mechanism. Project Designer 21 allows validation, error messages and dependencies to be specified between forms and their encompassed entities. Other options include list iterator, access control, configurations and a publishing mechanism. Project Designer 21 also provides management wizards with a central interface to manage all reusable resources, which include custom plug-ins, messages and styles.

Attribute Designer 22, Form Designer 23 and Project Designer 21 are toggled within Studio 20, subject to the user's access control rights. This ensures a consistent user interface and minimises confusion by eliminating multiple work spaces.

Plugins (not shown) are registered and graphically configured via Studio 20 to extend the business functionality required by a particular project. Plugins include external validators and processors. All registered plugins have all their associated parameters and properties configured graphically exactly in the same manner.

Plugins are able to interact and function seamlessly in Studio 20 once they are plugged in. Registered plugins are managed by Server 40.

The platform 10 uses an additional layer of abstraction to shield users from the underlying low level technical constructs. The abstraction anchors on business entities such as attributes, sections, pages and forms in increasing levels of granularity. These business entities permeate across the system and foster reuse within a single project, among different projects or across the entire enterprise. The platform 10 includes libraries 24, 25, 26 to collect and store business entities so that users are able to share and reuse these assets in subsequent projects. Business entities, attributes and forms can be shared at project, domain and enterprise levels.

The platform 10 appeals to business users since they are able to relate better to business entities rather than technical constructs found in typical tools which currently exist in the marketplace. The platform 10 is business centric, that is, it allows users to focus on business entities such as attribute, sections, forms and validation policies rather than lower level programming language codes. The platform 10 allows rapid prototyping since there is a coordinated effort from both business and technical users without compromising security, integrity and consistency. Concurrency control allows multiple team members to work simultaneously on the same project.

The platform 10 is responsible for enforcing a disciplined approach in realising best practices and consistency in developing forms for web applications. Permission control is built into the platform 10 so that specific permissions are assigned to team members of a project on a need-to-have basis, which also models the structure of the team and the responsibilities of the team members.

A form produced by the platform 10 is XForms 1.0 compliant and is conceptually composed of three main parts: the Model, the Instance and the User Interface (UI). Binding elements interconnect these main parts. A simple registration form in

<?xml version=“1.0” encoding=“iso-8859-1”?>
<envelope

xmlns:performa =“http://performa.crimsonlogic.com/2003/04/xforms”
xmlns:xforms=“http://www.w3.org/2002/08/xforms/cr”
xmlns:xlink=“http://www.w3.org/1999/xlink”>
<xforms:model>
<xforms:submission xforms:id=“bill-customer”
xforms:replace=“all”
xforms:action=“billing/bill-customer”
xforms:method=“post” />
<xforms:instance>
<name/>
</xforms:instance>

<xforms:bind xforms:id=“name” xforms:nodeset=“/name”/>
</xforms:model>

<performa:form id=“f0” name=“testform” desc=“Registration
Form”>
<performa:attr id=“a0” name=“nameattr” desc=“Name Section”>

<xforms:group>

<xforms:label>Hello </xforms:label>
<xforms:input xforms:id=“name-input” xforms:bind=“name”>
<xforms:label>Your name: </xforms:label>
</xforms:input>
<xforms:trigger xforms:id=“sendit”>
<xforms:label>Send </xforms:label>
<xforms:action>

<xforms:send xforms:id=“submit” <xforms:submission=“ bill-customer”/>

</xforms:action>
</xforms:trigger>
<xforms:trigger xforms:id=“reset-btn”>
<xforms:label>Reset</xforms:label>
<xforms:action>

<xforms:resetinstance xforms:id=“reset”/>

</xforms:action>
</xforms:trigger>
</xforms:group>

</performa:attr>

</performa:form>

</envelope>

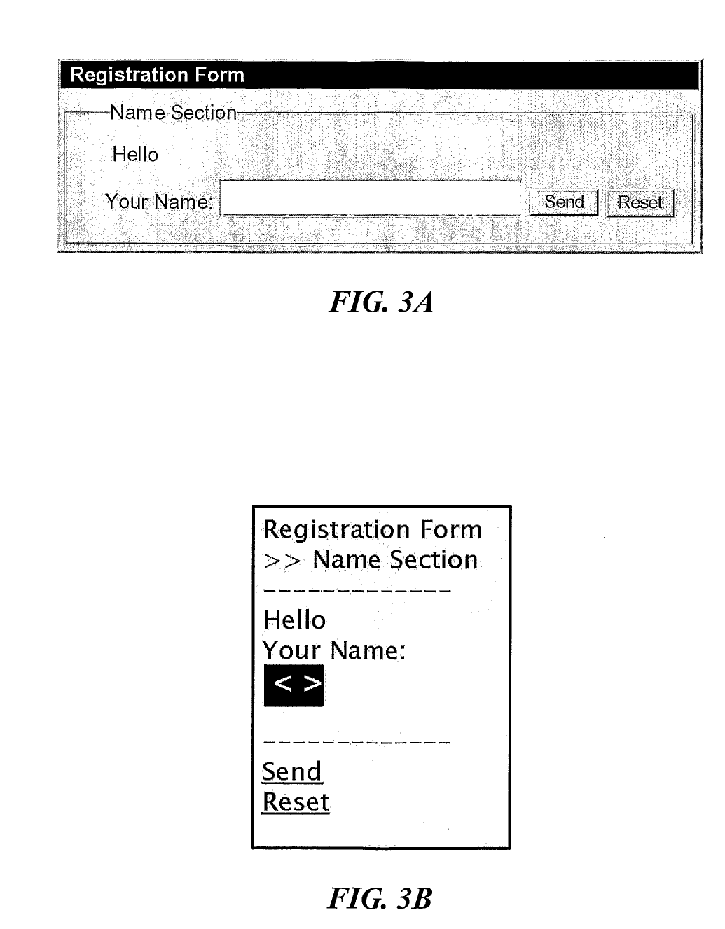

Based on the above form definition, the form display within a Web browser appears as FIG. 3A. Alternatively, the same form definition rendered within a mobile handset's WAP browser appears as FIG. 3B.

To enable target-device independence, the generic manner of the form is defined and the inherent separation of user interface, instance data and logic, is made to conform to the XForms standard. A generic form is interpreted in XForms syntax. The above form definition shows two child elements found inside the root element, “envelope” or any valid XML name in any namespace:

<xforms:model>—enclosed within this element is everything known about the form other than how it looks or otherwise be rendered. The model describes the initial instance data, a skeleton XML document containing the complete structure of the desired final document of the form within the “instance” element, as well as its associated model, such as data-types based on XML Schema, validation constraints and calculated values, using a combination of “bind” elements and XPath expressions. Actions like storing to disk or sending to backend systems are also defined here as “submission” elements.

<performa:form>—this section contains the user interface details of the form, which tells the platform the UI controls to be rendered or presented. The top-most “orm” element in the “performa” namespace identifies the document as a form definition familiar to the platform, while the “attr” child element constitutes a reusable business attribute that encompasses a group of form controls. From the example, form controls such as “input” and “trigger” are directly mapped to the textbox and button elements in HTML presentation respectively, provided the choice of display is HTML. Embedded within “trigger” elements are XForms Actions (“action” elements) which allows form logic to be declaratively authored. Examples of supported actions would include setting value of nodes in the model instance, insert or delete entries in collections, switch between different versions of UI and more.

During run-time, the xforms:model element is used to instantiate the form model while performa:form contents are interpreted to build the form UI and initialized with data from the model instance. The user is presented with the rendered form and can change values and submit the data with a click on the “Send” button. Upon submission, the platform inserts the form data into the model instance and outputs a HTML page which visualises the submitted data through “billing/bill-customer” specified within “submission” element.

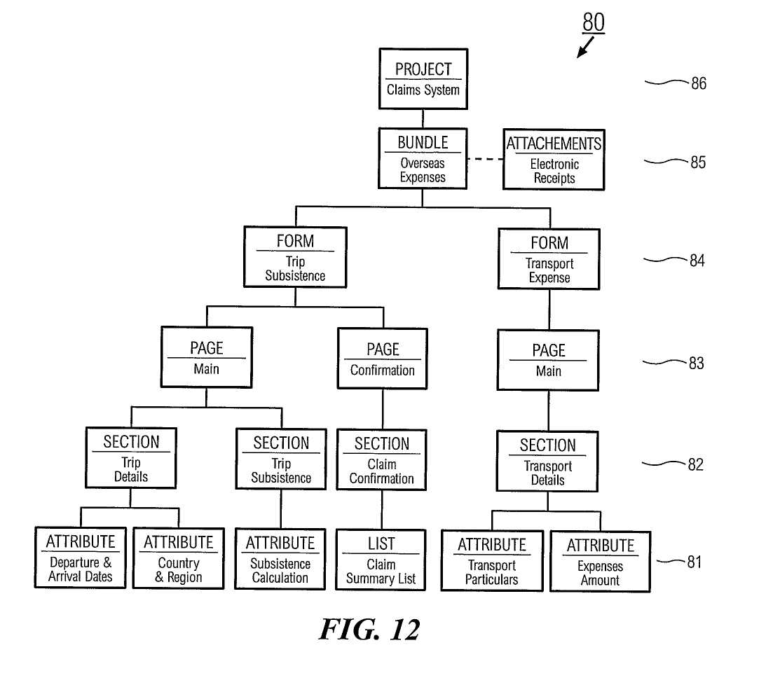

Referring to FIG. 12, a web application developed by the platform 10 adopts a logical and hierarchical conceptual model. This model distinguishes constituent entities of the web application spanning over five levels: Project, Bundle, Form, Page, Section and Attribute or List. For a web application to be valid, each logical level must be implemented and nested within the next higher level in the exact sequenced as described. For example, the simplest implementation would consist of a Project instance, which encompasses a Bundle instance, which encompasses a Form instance, followed by a Page Instance, Section instance and lastly an Attribute or List instance. This hierarchical organisation ensures implementation consistency, reliability and scaling to accommodate additional form entities.

FIG. 12 depicts an overseas expenditure form implementation 80. At the base level of the hierarchy are attribute and list entities 81, which are the fundamental form building blocks. An attribute 81 can be defined as a business form unit consisting of one or more form attributes 81 or controls for the primary purpose of gathering user input. These include text input fields, drop down lists, checkbox or radio button input selection. Each form control within an attribute 81 is associated with specific data-type and validation checks to reflect business usage constraints. Spreadsheet style arithmetic functions can also be specified for relevant form controls to perform simple calculations.

Similar to attributes 81, list iterators are also base level entities, but are different in terms of its primary purpose. Lists display rather than collect data. A list item is commonly used in applications to present existing data in a tabular manner to provide a summary or index view. Often, data within a list is organised into table columns, which are sortable in ascending or descending order. In the platform 10 lists are able to support data retrieved directly from a database or referenced from in-memory form data instances within the same bundle space.

Sections 82 are logical blocks that allow grouping of attributes 81 mainly for categorisation purposes. Based on this grouping, it is possible to perform collective tasks as a whole, such as group labeling, overlay operations and application of style themes.

Encompassing sections are pages 83, which are commonly used to split a lengthy form into a jointed series of screen-sized pages to minimise scrolling on a video display. Pages typically include a variety of paging mechanisms to maximise navigation ease and each page is akin to a self-contained form in terms of error checking and display. Input errors are immediately notified to users. Input error in a page can render other inputs in subsequent pages as erroneous and data re-entry is required.

Forms 84 are complete and self-contained entities and are workflow capable. Forms 84 participate in approval routing of an adhoc or structured nature. During the approval routing process, approvers can attach supporting documents or any other electronic resources as reference. As such, a particular form 84 may optionally be linked to attachments, and be collectively known as a bundle 85. Bundles 85 also refer a set of related forms or attachments which reference each other. For example, the “Overseas Expenses” bundle 85 encompasses the “Trip Subsistence” form 84 and the “Transport Expense” form 84. The “Transport Expense” form 84 is a sub-form of the “Trip Subsistence” form 84.

The hierarchical model converges at the project entity 86 situated at the root level. At the root level, distinct forms 84 and bundles 85 are linkable to specify workflow modules or integrated with external applications through URL re-direction. Here, project-specific configurations are set to effect changes that propagate throughout the model to the attributes level. An example is specifying a set of standard styles that enforce look and feel consistency at all levels. Other configurations are possible such as access control, version control, forms publishing mechanism and filtering of entity repositories.

### Example

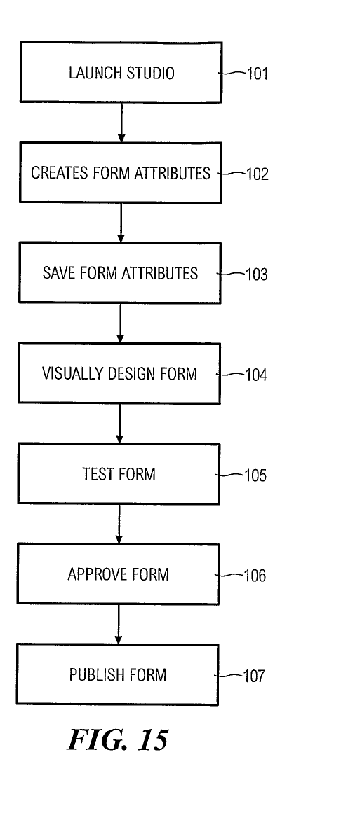

Referring to FIG. 15, in a typical scenario, a developer launches 101 Studio 20 from the desktop to begin creating a new web application. The developer creates 102 the necessary form attributes using Attribute Designer 22 based on a selection of library attributes. In an example of a registration form, the developer aligns several atomic attributes such as “Street”, “Unit No” and “ZIP Code” and groups them together as a composite “Address” attribute, together with “User ID”, “Password” and “E-Mail” attributes. For each field, pre-configured presentation styles are specified and assigned the appropriate validation rules and policies. The created attributes are then saved 103 to a project-specific repository, which can be retrieved and reused for subsequent new forms.

Next, the developer or another team member invokes Form Designer 23 and visually designs 104 the form by dragging and dropping previously created attributes into the desired layout format. Additional controls such as paging, pre/post processing, output redirection, error display format and routing options will also be made available for configuration. After completing the form design, the developer is able to run and preview the form from Project Designer 21 immediately. Subsequently, the form is automatically routed through an approval process 106 before published 107 for live access. With segregation of duties, in typical situations, a developer is not granted access to all three designers 21, 22, 23.

Referring to FIG. 17, once the form is live, business users are able to perform form submissions and track the associated approval route from the centralised Office 30. Office 30 includes an “Inbox” mechanism for approvers to manage and approve routed forms in an organised and convenient manner. The Inbox allows access to individual forms where only those forms or attachments currently associated with a particular user are seen in their Inbox. Users can preview form contents, track route information, approve forms, reject forms, attach documents, insert comments, as well as specify route destinations from their Inbox. For form submitters, a facility is provided to amend and re-submit rejected forms or retrieve partially filled forms to resume data entry. Future form enhancements are possible for the developer by simply performing a few mouse click operations to effect changes in field types, attributes layout or even the entire presentation format. Office 30 also includes an Out-of-Office Mechanism to allow users to indicate they are not in the office and accordingly specify route re-direction or alternative actions. Other features included in Office 30 are a Forms Archive, Printing and Export modules, and Administration functions.

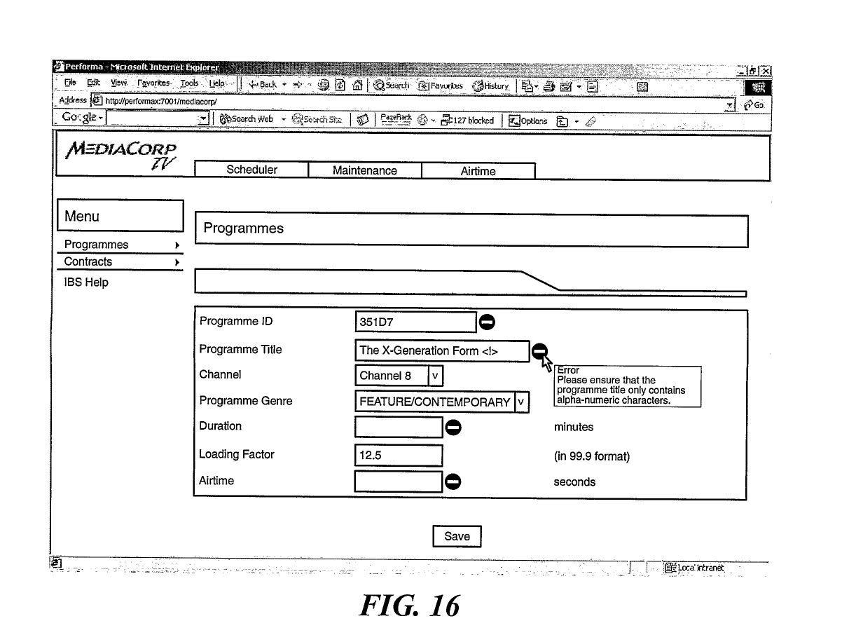

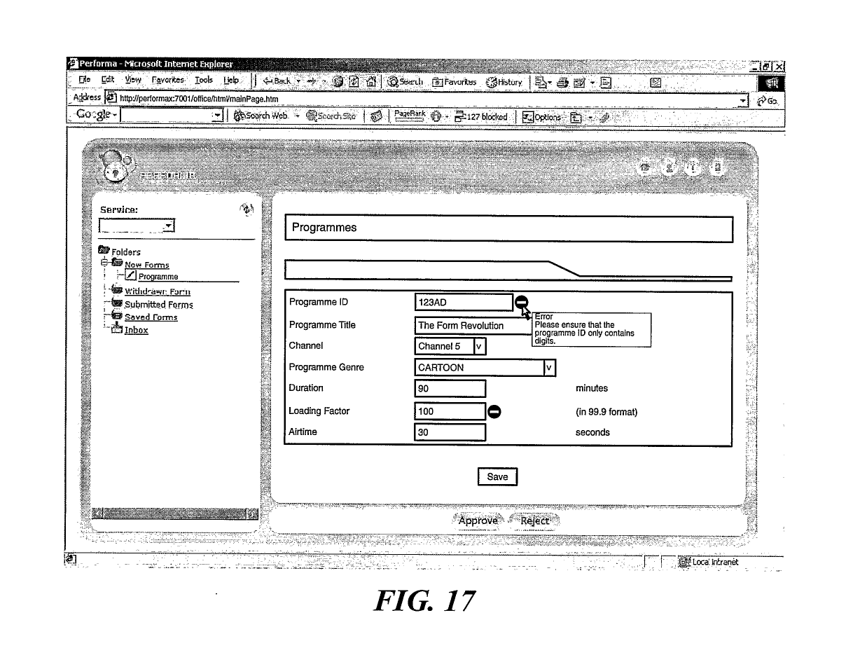

Alternatively, published forms are also able to be integrated with existing web applications through URL re-directing. This is illustrated in FIG. 16.

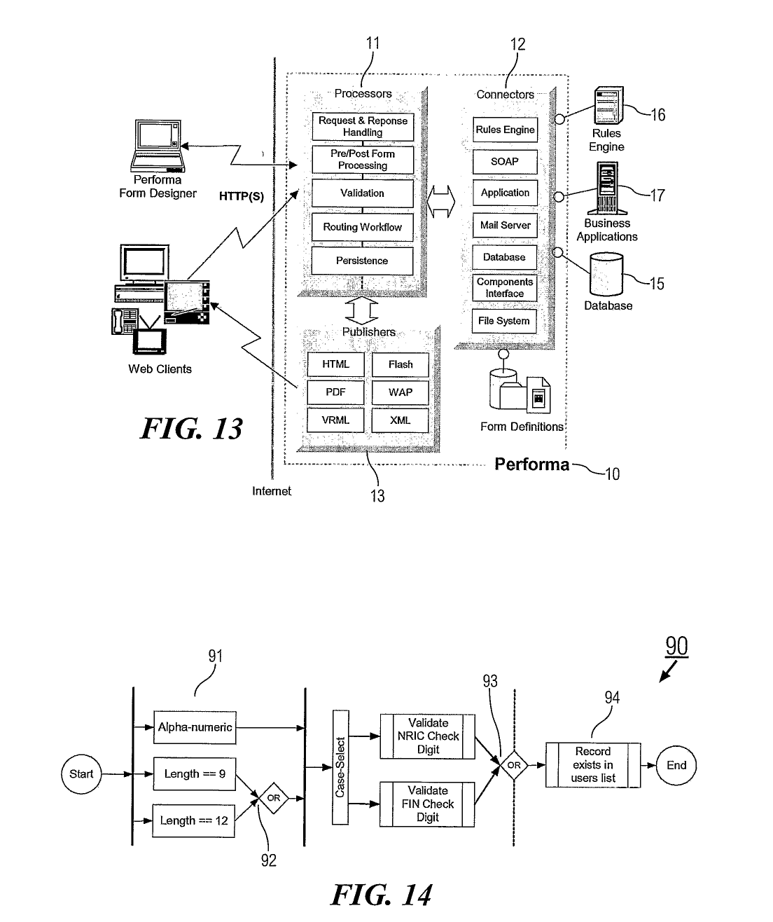

Referring to FIG. 13, the architecture of Server 40 comprises three functional layers, namely, processors 11, connectors 12 and publishers 13. The processors layer 11 constitutes the core command and control operations of the platform 10 and encompasses specialised processors 11 which are functionally distinct and loosely coupled from each other. These processors 11 include Request and Response Handling, Pre/Post Form Processing, Validation, Routing Workflow and Persistence. In a typical web request to the platform 10 from a client, a pipelined process is spawned and depending on the pipeline configuration settings, various processors 11 can be interchanged or combined to service the request.

Processors 11 interact with the connectors layer 12 for connectivity to external systems, such as databases 15, rules engines 16 and other business applications 17. The connectors layers 12 encapsulates system integration specifics through robust connect agents, which contain the interfacing ability with external systems, while maintaining a consistent application access interface.

The publishers layer 13 provides multi-target presentation capabilities for the framework by transforming XML form instances into various markup syntax which can be understood and rendered by the target device. Each component of the publisher layer 13 maintains a transformation style sheet for mapping intrinsic form elements created by the system into intended target element types. Publishing formats provided by the publishing components include HTML, Macromedia Flash, PDF, WML, VRML and XML.

The platform 10 structures development tasks involved in developing forms for a web-based application according to the role played by a team member. The segregation of duties allows the development task to be tailored accordingly to the responsibilities and capabilities of the respective team member. This ensures that every team member is only permitted to perform the functions they are assigned to. Individual developers working on the same project are coordinated and synchronised. This allows the development team to be scalable and permits outsourcing of development work to be achieved without sacrificing control.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

1. platform for developing forms, comprising:
an attribute design module configured to graphically design reusable form attributes from a selection of predetermined fields, the attributes having integrated business logic;
a form design module configured to graphically design reusable forms using the form attributes, the forms having integrated business logic; and
a project design module configured to design reusable projects by graphically arranging the forms according to a predetermined process flow;
wherein the design modules are configured to operate independently from each other such that the design of the attributes, forms and projects are separate functions, and designed attributes, forms and the projects are stored as separate entities.

2. The platform according to claim 1, further comprising an attribute library to store designed attributes, a form library to store designed forms and a project library to store designed projects.

3. The platform according to claim 1, further comprising a validation engine to validate a form.

4. The platform according to claim 3, wherein the form is validated against an open standard or validated against an internal business policy of a business.

5. The platform according to claim 3, wherein the form is validated to comply with a security policy such as checking for SQL or script injection.

6. The platform according to claim 4, wherein the internal business policy is stored in a validation policy repository to facilitate re-usability.

7. The platform according to claims 1, further comprising an approval system to enable forms to be approved prior to publishing.

8. The platform according to claim 7, wherein the approval system is a centralized system.

9. The platform according to claim 7, wherein the approval system includes:
an linbox configured to allow access to individual forms associated with certain users;
an out-of-office mechanism configured to allow users to indicate an out-of-office status and specify route re-direction or alternative actions;
a forms archive configured to allow forms to be searchable and filtered;
printing module configured to allow forms to be printed in a printer-friendly format;
export module configured to allow users to export form data in XML or other formats; or
an administration module configured to allow remote configuration and monitoring of all forms and their associated routing processes.

10. The platform according to claims 1, wherein the form is interpreted to generate a form or series of related forms in HTML, wireless markup language (WML) or other language for presentation on a specific device or operating system.

11. The platform according to claims 1, wherein the predetermined fields includes input fields selected from at least one of the following: as text fields, password fields and image fields.

12. The platform according to claims 1, wherein the attribute designer module specifies validation, error message and dependencies for form controls within an attribute.

13. The platform according to claims 1, wherein the attributes are hierarchically designed.

14. The platform according to claim 13, wherein validation of a form is nested at predetermined levels.

15. The platform according to claims 1, wherein the form designer module designs page flows.

16. The platform according to claims 1, wherein the form designer module specifies validation, error messages and dependencies for attributes, sections and pages within a form.

17. The platform according to claims 1, wherein the form designer module specifies list iterators, action types, paging mechanism, preform and post-form processing and form persistence.

18. The platform according to claims 1, wherein backend business services are linked to the predetermined process flow.

19. The platform according to claims 1, wherein the form designer module further designs forms with sections and pages.

20. The platform according to claims 1, wherein the project designer module centrally manages styles, messages, and plugins for a project.

21. The platform according to claims 1, wherein the project designer module specifies list iterators, access control, configurations and a publishing mechanism.

22. The platform according to claims 1, wherein business logic contained within designed attributes and forms includes validation rules for form input while data is being entered.

23. The platform according to claims 1, wherein business logic contained within designed attributes and forms includes equations or calculators to generate a useful result.

24. A method Of developing forms, comprising:
graphically designing reusable form attributes from a selection of predetermined fields, the attributes having integrated business logic;
graphically designing reusable forms using the form attributes, the forms having integrated business logic; and
designing reusable projects by graphically arranging the forms according to a predetermined process flow;
wherein the design of the attributes, forms and projects are separate functions, and designed attributes, forms and the projects are stored as separate entities.

25. A form developed by a method, wherein the method comprises:
graphically designing reusable form attributes from a selection of predetermined fields, the attributes having integrated business logic;
graphically designing reusable forms using the form attributes. the forms having integrated business logic; and
designing reusable projects by graphically arranging the forms according to a predetermined process flow;
wherein the design of the attributes, forms and projects are separate functions, and designed attributes, forms and the projects are stored as separate entities.

26. The method according to claim 24, further comprising
providing a graphical user interface to allow a user to perform the steps of graphically designing reusable form attributes, graphically designing reusable forms and designing reusable projects.

27. A computer-readable medium for carrying computer-executable instructions for:
graphically designing reusable form attributes from a selection of predetermined fields, the attributes having integrated business logic;
graphically designing reusable forms using the form attributes, the forms having integrated business logic; and
designing reusable projects by graphically arranging the forms according to a predetermined process flow;
wherein the design of the attributes, forms and projects are separate functions, and designed attributes, forms and the projects are stored as separate entities.

28. A platform for developing forms, comprising:
means for graphically designing reusable form attributes from a selection of predetermined fields, the attributes having integrated business logic;
means for graphically designing reusable forms using the form attributes, the forms having integrated business logic; and
means for designing reusable projects by graphically arranging the forms according to a predetermined process flow,
wherein the design of the attributes, forms and projects are separate functions, and designed attributes, forms and the projects are stored as separate entities.
